(19) United States
(12) Patent Application Publication
(10) Pub. No.: US 2013/0251168 A1
(43) Pub. Date: Sep. 26, 2013

(54) AMBIENT INFORMATION NOTIFICATION APPARATUS

(71) Applicant: DENSO CORPORATION, Kariya-city (JP)

(72) Inventor: Takashi TAKAZAWA, Obu-city (JP)

(73) Assignee: DENSO CORPORATION, Kariya-city (JP)

(21) Appl. No.: 13/848,154

(22) Filed: Mar. 21, 2013

(30) Foreign Application Priority Data
Mar. 22, 2012 (JP) 2012-65584

(51) Int. Cl. H04R 29/00

(52) U.S. Cl. CPC H04R 29/00
USPC 381/66; 381/86

(57) ABSTRACT

An ambient information notification apparatus includes: an interior sound acquisition device acquiring an interior sound in a compartment of the vehicle; an ambient information presentation sound generator generating an ambient information presentation sound; and an ambient information presentation sound output device outputting the ambient information presentation sound. The ambient information presentation sound satisfies that a sound pressure level of the ambient information presentation sound is higher than the interior sound in a predetermined frequency band, and is lower than or equal to the interior sound in other frequency band, and that the ambient information presentation sound is provided by stereophony, in which a sound image localization direction approximately directs to a virtual sound source.

### CROSS REFERENCE TO RELATED APPLICATION

This application is based on Japanese Patent Application No. 2012-65584 filed on Mar. 22, 2012, the disclosure of which is incorporated herein by reference.

### TECHNICAL FIELD

The present disclosure relates to an ambient information notification apparatus for notifying a driver of a vehicle about ambient information.

### BACKGROUND

Conventionally, there is known an onboard apparatus that recognizes a road sign, a crossing, or a traffic signal and audibly notifies a driver of the recognized information (see patent document 1).

The technology described in patent document 1 may output sound even if the sound is unneeded, for example, if a driver already recognizes a road sign. In such a case, the driver may feel inconvenience.
[Patent document 1] JP-A-2003-23699

### SUMMARY

It is an object of the present disclosure to provide an ambient information notification apparatus for notifying a driver of a vehicle about ambient information. The apparatus does not provide inconvenience to the driver.

According to an example aspect of the present disclosure, an ambient information notification apparatus for a vehicle includes: an interior sound acquisition device that acquires a sound in a compartment of the vehicle, which is referred as an interior sound; an ambient information presentation sound generator that generates an ambient information presentation sound, which satisfies a first condition and a second condition with regard to the interior sound; and an ambient information presentation sound output device that outputs the ambient information presentation sound. The first condition is that a sound pressure level of the ambient information presentation sound is higher than the interior sound in a predetermined frequency band, and is lower than or equal to the interior sound in other frequency band. The second condition is that the ambient information presentation sound is provided by stereophony, in which a sound image localization direction approximately directs to a virtual sound source.

The ambient information notification apparatus can output an ambient presentation sound if a driver fails to notice a traffic signal or a road sign, for example. This can prevent a failure to notice the traffic signal or the road sign.

The ambient presentation sound is generated based on the interior sound so as to satisfy the first condition described above. The driver does not feel annoyed if the ambient presentation sound is output continuously under a situation where there is no need to output the sound.

The ambient presentation sound provides stereophony that satisfies the second condition described above. The driver can easily recognize an object notified by the ambient presentation sound.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram illustrating a configuration of a sound presentation apparatus;

FIG. 2 is a block diagram illustrating a configuration of a three-dimensional sound image localization apparatus;

FIG. 3 is a block diagram illustrating configurations of a sensor apparatus and an interior/exterior situation recognition device;

FIG. 4 is an explanatory diagram illustrating placement of exterior microphones and loudspeakers and propagation of actual background sound;

FIG. 5 is a flowchart illustrating an ambient information presentation sound generation process;

FIG. 6 is a flowchart illustrating a presentation sound generation step;

FIG. 7 is a flowchart illustrating a virtual sound image localization parameter calculation step;

FIG. 8 illustrates a noise spectrum in a vehicle;

FIG. 9 illustrates a pink noise spectrum;

FIG. 10 illustrates an ambient information presentation sound spectrum;

FIG. 11 illustrates an alarm sound spectrum;

FIG. 12 is an explanatory diagram illustrating calculation of a virtual sound image localization parameter used when the vehicle is running on a bank;

FIG. 13 is an explanatory diagram illustrating calculation of a virtual sound image localization parameter used when the vehicle is running on a limited highway;

FIG. 14 is an explanatory diagram illustrating calculation of a virtual sound image localization parameter used when the vehicle is running on an elevated highway;

FIG. 15 is a flowchart illustrating an ambient information presentation sound output process performed when a traffic signal (green light or arrow) is recognized;

FIG. 16 is a flowchart illustrating the ambient information presentation sound output process performed when a traffic signal (yellow or red light) is recognized;

FIG. 17 is a flowchart illustrating the ambient information presentation sound output process performed when a speed sign is recognized; and

FIG. 18 is a flowchart illustrating the ambient information presentation sound output process performed when a no-entry sign is recognized.

### DETAILED DESCRIPTION

An embodiment of the present disclosure will be described in further detail with reference to the accompanying drawings.

1. Configuration of a Sound Presentation Apparatus 1

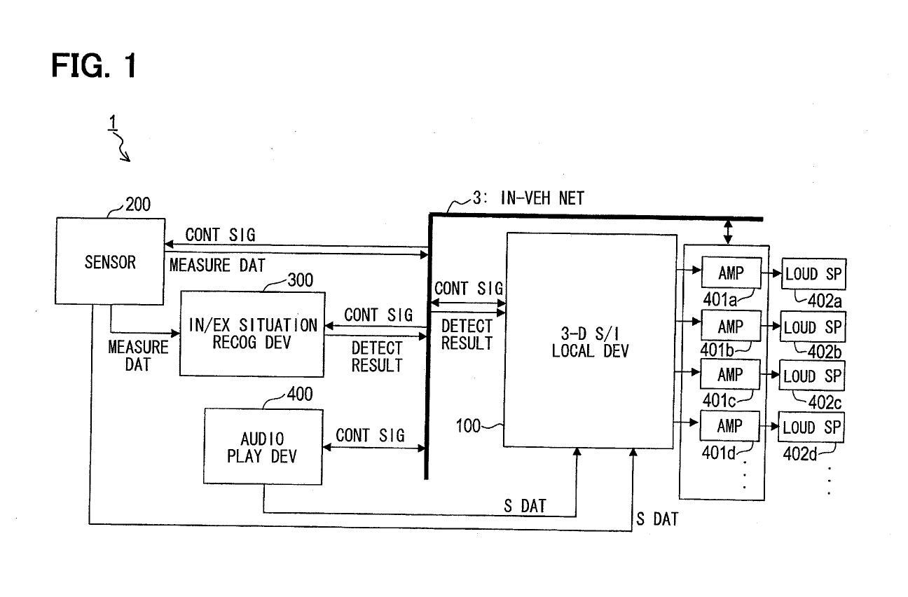

The configuration of the sound presentation apparatus 1 will be described with reference to FIGS. 1 through 4. As illustrated in FIG. 1, the sound presentation apparatus 1 includes a three-dimensional sound image localization apparatus (equivalent to an ambient information presentation sound generation device or an reflection/reverb condition setup device) 100, a sensor apparatus (equivalent to a first or second situation detection device) 200, an interior/exterior situation recognition device 300, an audio playing apparatus 400, amplifiers (equivalent to an ambient information presentation sound output device) 401a through 401k, and loudspeakers (equivalent to the ambient information presentation sound output device) 402a through 402k. An in-vehicle network 3 interconnects these components. The amplifiers 401a through 401k are connected to the in-vehicle network 3.

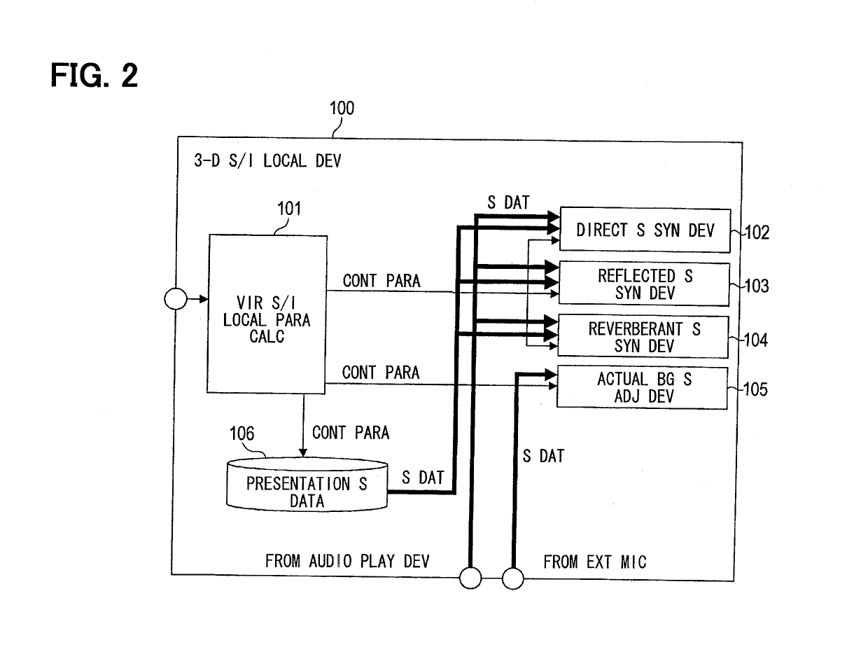

As illustrated in FIG. 2, the three-dimensional sound image localization apparatus 100 includes a virtual sound image localization parameter calculation device 101, a direct sound synthesis device 102, a reflected sound synthesis device 103, a reverberant sound synthesis device 104, an actual background sound adjustment device 105, and a presentation sound data 106.

The virtual sound image localization parameter calculation device 101 is supplied with information transmitted from various sensors (to be described) included in the sensor apparatus 200 via the in-vehicle network 3. Based on the supplied information, the virtual sound image localization parameter calculation device 101 determines whether to (i) immediately present, (ii) present later, or (iii) not present one or more of sounds (hereinafter referred to as sources) such as reproduced audio sound and presentation sound.

To present the sound, the virtual sound image localization parameter calculation device 101 settles a source to be presented, the loudness, the presentation direction and distance, and other parameters (control parameters) needed for the synthesis. The virtual sound image localization parameter calculation device 101 then notifies the control parameters to the direct sound synthesis device 102, the reflected sound synthesis device 103, the reverberant sound synthesis device 104, and the actual background sound adjustment device 105. The virtual sound image localization parameter calculation device 101 may settle control parameters for reflected or reverb sound based on information from a car navigation system 303.

The direct sound synthesis device 102 processes signals on the specified source based on the parameters notified from the virtual sound image localization parameter calculation device 101. This signal process synthesizes interior sound fields from the loudspeakers 402a through 402k as if the sound were radiated from a specified position (virtual sound source).

The reflected sound synthesis device 103 processes signals on the specified source based on the parameters notified from the virtual sound image localization parameter calculation device 101. This signal process synthesizes interior sound fields from the loudspeakers 402a through 402k as if the sound radiated from a specified position (virtual sound source) were reflected from a nearby reflector to reach the interior.

The reverberant sound synthesis device 104 processes signals on the specified source based on the parameters notified from the virtual sound image localization parameter calculation device 101. This signal process synthesizes interior sound fields from the loudspeakers 402a through 402k as if the sound radiated from a specified position (virtual sound source) were reflected and reverberated from a nearby reflector.

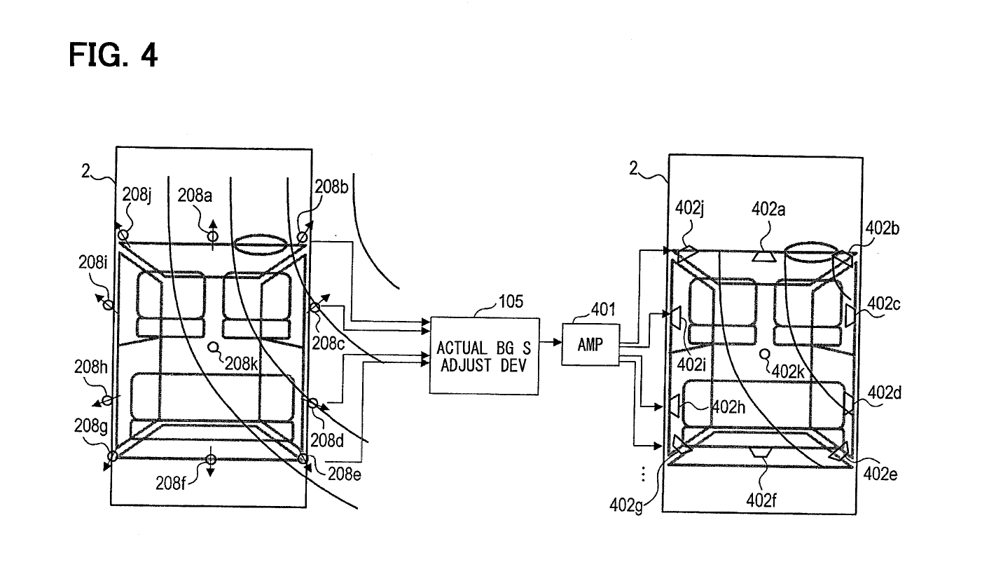

As illustrated in FIG. 4, the actual background sound adjustment device 105 processes signals for sound data collected by exterior microphones 208a through 208k (to be described) included in the sensor apparatus 200 so that an exterior sound field can be reproduced in the interior.

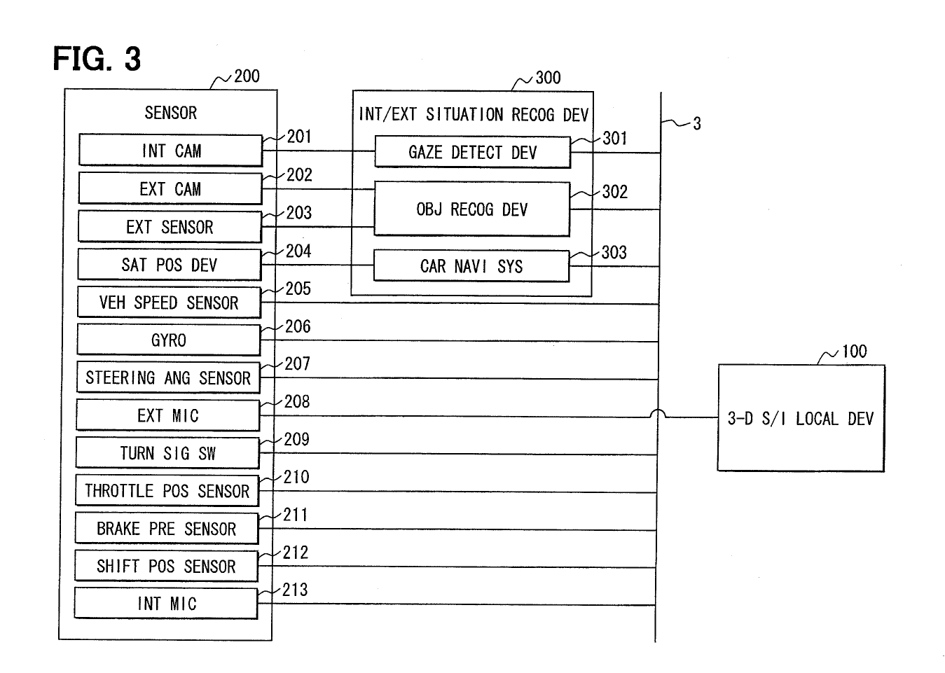

As illustrated in FIG. 3, the sensor apparatus 200 includes an interior camera 201, an exterior camera 202, an exterior sensor 203, a satellite positioning apparatus 204, a vehicle speed sensor 205, a gyro sensor 206, a steering angle sensor 207, an exterior microphone 208, a turn signal switch 209, a throttle position sensor 210, a brake pressure sensor 211, a shift position sensor 212, and an interior microphone (interior sound acquisition device) 213. Several functions of the sensors may be integrated into a sensor apparatus. Alternatively, each of the sensors may function as an independent sensor apparatus.

The interior camera 201 provides an image sensor that is provided in the interior and is directed to a driver. The interior camera 201 transmits image data to a gaze detection device 301 to be described.

The exterior camera 202 provides one or more image sensors directed to the exterior and transmits image data to an object recognition device 302 to be described.

The exterior sensor 203 detects an exterior object and transmits detection data to the object recognition device 302 to be described. The exterior sensor 203 is equivalent to a known sensor that uses ultrasonic waves, millimeter waves, submillimeter waves, or near-infrared light.

The satellite positioning apparatus 204 observes radio waves from a satellite and calculates absolute position coordinates on the land surface based on an observation result. The satellite positioning apparatus 204 notifies a calculation result to the car navigation system 303 to be described.

The vehicle speed sensor 205 detects the number of revolutions from a tire, a drive shaft, or other vehicle parts related to the vehicle speed. The vehicle speed sensor 205 transmits a detection result to the in-vehicle network 3.

The gyro sensor 206 is equivalent to a gyroscope mounted on a vehicle 2. The gyro sensor 206 converts angular acceleration around X, Y, and Z axes into numeric values and transmits them to the in-vehicle network 3.

The steering angle sensor 207 detects a driver-operated steering angle, converts the angle into numeric values and transmits them to the in-vehicle network 3.

The exterior microphone 208 collects the sound outside the vehicle 2 and outputs the collected sound to the three-dimensional sound image localization apparatus 100. The exterior microphone 208 is specially designed to be free from an effect of the wind during vehicle running. As illustrated in FIG. 4, more than one exterior microphone 208 is provided. The exterior microphones 208 are placed so densely as to be able to reproduce the sound field outside the vehicle 2 in the interior. Where necessary, the exterior microphones 208 may be denoted by reference numerals 208a through 208k for distinction. The actual background sound adjustment device 105 processes signals acquired by the exterior microphones 208a through 208k. The amplifiers 401a through 401k and the loudspeaker 402a through 402k audibly present the processed signal in the interior.

The turn signal switch 209 operates right and left turn signals the driver directly operates. The turn signal switch 209 converts a state of the switch into numeric values and transmits them to the in-vehicle network 3.

The throttle position sensor 210 detects the amount of operation on a driver-operated throttle. The throttle position sensor 210 converts a result into numeric values and transmits them to the in-vehicle network 3.

The brake pressure sensor 211 detects the amount of operation on a driver-operated brake. The brake pressure sensor 211 converts a result into numeric values and transmits them to the in-vehicle network 3.

The shift position sensor 212 detects the position of a driver-operated shift lever. The shift position sensor 212 converts a result into numeric values and transmits them to the in-vehicle network 3.

The interior microphone 213 includes more than one microphone to collect the sound inside the vehicle 2 and a processor. The interior microphone 213 calculates the sound pressure level or spectrum of an interior noise from the collected sound and notifies a result to the in-vehicle network 3. The interior microphone 213 may be also used for a microphone for a speech recognition apparatus of the car navigation system or a handsfree phone.

As illustrated in FIG. 3, the interior/exterior situation recognition device 300 includes the gaze detection device 301, the object recognition device 302, and the car navigation system 303. These devices may be installed in one apparatus according to functions or may be installed in individual apparatuses.

The gaze detection device 301 detects a driver's gaze based on imaged data acquired from the interior camera 201. The gaze detection device 301 transmits a detection result to the in-vehicle network 3.

The object recognition device 302 monitors objects all around the running vehicle 2 in vertical, horizontal, and longitudinal directions based on the information acquired from the exterior camera 202 and the exterior sensor 203. The object recognition device 302 recognizes information about surrounding objects (e.g., road sign, traffic signal, wall, ceiling, oncoming vehicle, and nearby traffic). The object recognition device 302 transmits a recognized result to the in-vehicle network 3. The object recognition device 302 extracts information about an object (of predetermined type) needed to attract driver's attention from the recognized information. The object recognition device 302 also transmits this recognized result to the in-vehicle network 3. The in-vehicle network 3 transmits the recognized result to the virtual sound image localization parameter calculation device 101. The virtual sound image localization parameter calculation device 101 receives the recognized result and notifies the direct sound synthesis device 102, the reflected sound synthesis device 103, and the reverberant sound synthesis device 104 of control parameters for direct sound, reflected sound, and reverb sound to be presented.

The car navigation system 303 calculates the vehicle position, the position relative to a destination, and a route based on the information acquired from the satellite positioning apparatus 204, the vehicle speed sensor 205, and the gyro sensor 206, and built-in map data. The car navigation system 303 notifies a result to the in-vehicle network 3 and displays the result on a display (not illustrated).

The audio playing apparatus 400 is equivalent to a CD, MD, DVD, BD, TV, or AM/FM radio set. The audio playing apparatus 400 outputs the sound signal to the three-dimensional sound image localization apparatus 100 and notifies a playing state to the in-vehicle network 3.

As illustrated in FIG. 4, the loudspeakers 402a through 402k are placed at a specified interval in the interior so as to surround the vehicle compartment. The loudspeakers 402a through 402k can output the sound to the inside of the vehicle compartment.

2. Processes Performed by the Sound Presentation Apparatus 1

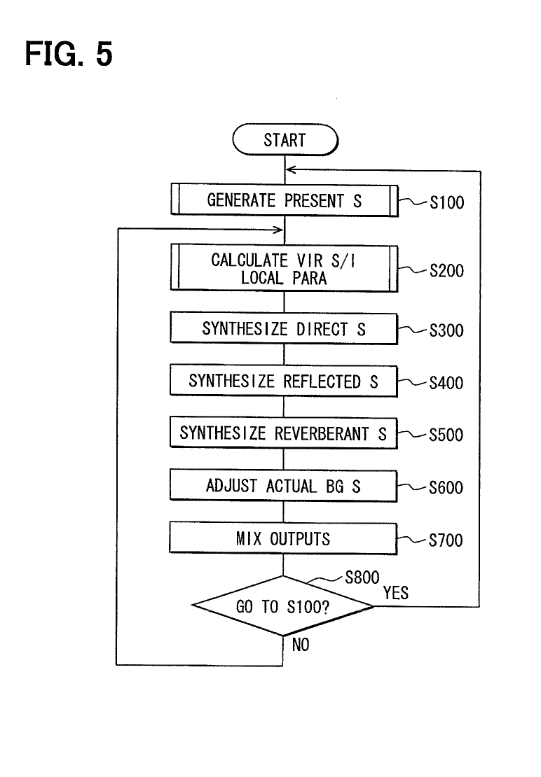

Processes performed by the sound presentation apparatus 1 will be described with reference to FIGS. 5 through 18.

(2-1) Ambient Information Presentation Sound Generation Process

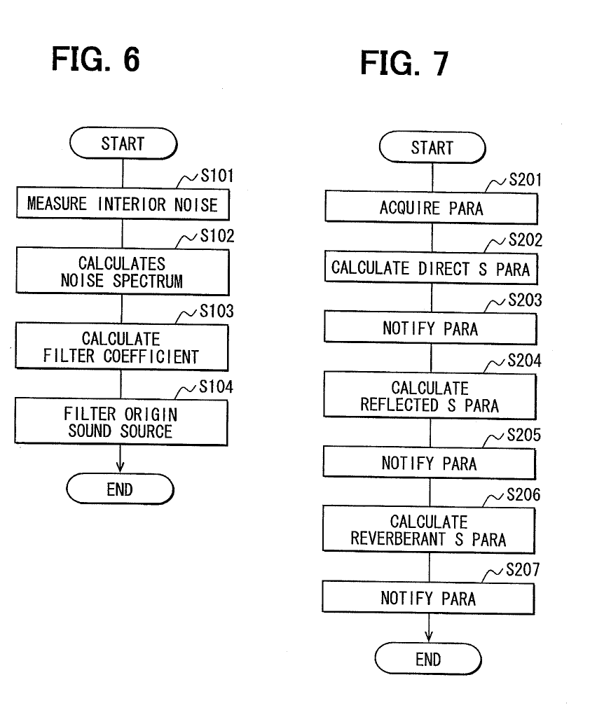

The ambient information presentation sound generation process will be described. At S100 in FIG. 5, the sound presentation apparatus 1 generates an ambient information presentation sound. This process generates output from the presentation sound data 106. This process will be described in detail with reference to FIG. 6.

At S101, the sound presentation apparatus 1 uses one or more interior microphones 213 to measure an interior noise.

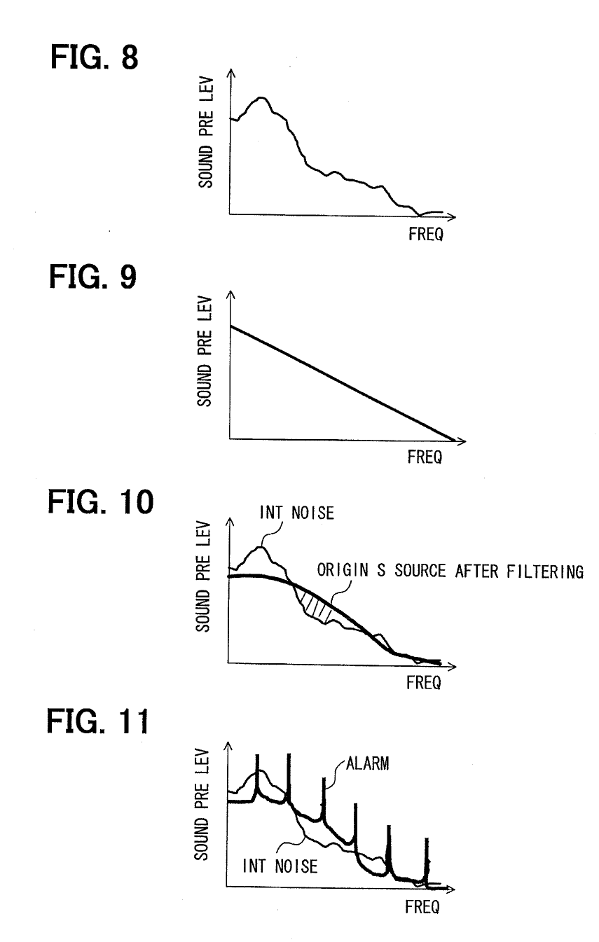

At S102, the sound presentation apparatus 1 calculates a spectrum for the noise measured at S101 to estimate an interior noise spectrum. The sound presentation apparatus 1 calculates the spectrum by generating short-time frames (several milliseconds to seconds) and analyzing a frequency at each frame. The sound presentation apparatus 1 further smoothes frequency bands within a frame at the same time or smoothes the same frequency band between frames at different times in chronological order. Alternatively, the sound presentation apparatus 1 may perform both processes. The process generates an interior noise spectrum as illustrated in FIG. 8.

At S103, the sound presentation apparatus 1 calculates a filter coefficient from the noise spectrum acquired at S102. The filter coefficient is characterized as follows.

The sound presentation apparatus 1 previously retains pink noise (origin sound source) as the presentation sound data 106 according to a spectrum as illustrated in FIG. 9. The origin sound source is equivalent to sound data used for processes to be described. The origin sound source may be a continuous sound such as pink noise or white noise or may be a periodic sound containing many harmonics such as pulse train or square waves.

The sound presentation apparatus 1 applies a filtering process using the filter coefficient to the origin sound source. FIG. 10 illustrates the origin sound source after the filtering process. In some frequency bands (intermediate frequency bands), the sound pressure is higher than the sound pressure level of the interior noise. As a result, the filtered origin sound source is not masked by noise in the bands. In the other frequency bands, the sound pressure is lower than the sound pressure level of the interior noise. As a result, the filtered origin sound source is masked by noise in the bands.

The filter coefficient is calculated so that the filtered origin sound source is characterized as described above. Where necessary, the filter coefficient may amplify or attenuate part of the spectrum. The filtered origin sound source is used as a source of the ambient information presentation sound in the following description. The ambient information presentation sound is not hidden from the background sound. The presentation sound data 106 retains the ambient information presentation sound source. The sound presentation apparatus 1 also retains a source for the alarm sound having the spectrum as illustrated in FIG. 11 in the presentation sound data 106.

At S200 in FIG. 5, the virtual sound image localization parameter calculation device 101 calculates a virtual sound image localization parameter. This process will be described in detail with reference to FIG. 7.

At S201 in FIG. 7, the virtual sound image localization parameter calculation device 101 acquires information output from the gaze detection device 301, information output from the object recognition device 302, and information output from the car navigation system 303 via the in-vehicle network 3.

The gaze detection device 301 outputs information about where the driver's gaze is directed. The object recognition device 302 outputs the following parameter information about surrounding objects.

<Information about the Environment Around the Vehicle>
Presence or absence of a reflecting wall (including a ceiling or a road) in vertical, horizontal, or longitudinal direction
Distance to and direction of a reflecting wall in vertical, horizontal, or longitudinal direction
Reflection coefficient of a reflecting wall in vertical, horizontal, or longitudinal direction
Reverberation time for each frequency band in a space where the vehicle is located

<Information about Recognized Objects>
The number of objects, direction, distance, object size, and object type (e.g., road sign, traffic signal, truck, or bicycle)

The information output from the car navigation system 303 is equivalent to the information output from the object recognition device 302. The latter information results from collating the position of the vehicle 2 with the map data.

An ultrasonic wave sensor, a millimeter wave sensor, a submillimeter wave sensor, a laser radar, and a visible-light stereo camera may be used in combination to determine the presence or absence of a reflecting wall, the distance to or direction of a reflecting wall, a wall reflection coefficient, and the reverberation time for each frequency band in a space where the vehicle is located. Alternatively, the car navigation system 303 may be used to determine the parameter information by matching the vehicle position to a predetermined map database.

At S202, the virtual sound image localization parameter calculation device 101 calculates a direct sound image coordinate to localize the direct sound of the presentation sound based on the parameter acquired at S201. The direct sound image coordinate represents the position of the virtual sound source. The virtual sound source position may equal the position of a recognized object, for example. Alternatively, the virtual sound source may be positioned in the direction of the driver's gaze. Calculating the direct sound image coordinate can provide the direct sound synthesis device 102 with the distance information as well as the direction information. The direct sound synthesis device 102 can simulate the distance attenuation effect of decreasing the loudness in proportion to the increasing distance, the Doppler effect based on an action of moving toward or away from an object, and the curvature radius of a wavefront of sound wave varying with the distance to the sound source. In this manner, the actual environment outside the vehicle can be simulated.

At S202, the virtual sound image localization parameter calculation device 101 selects a presentation sound source. As described above, there are available sources for ambient information presentation sound and alarm sound. The source for ambient information presentation sound is selected when the ambient information presentation sound is generated.

At S202, the virtual sound image localization parameter calculation device 101 settles a high-frequency distance attenuation correction parameter. If an object is distant from the vehicle 2, a sound attenuation due to the air tends to decrease energy at a high frequency band more than energy at a low frequency band. A known method is used to settle a coefficient to simulate this phenomenon.

At S203, the virtual sound image localization parameter calculation device 101 notifies the parameter calculated at S202 to the presentation sound data 106 and the direct sound synthesis device 102.

At S204, the virtual sound image localization parameter calculation device 101 calculates a reflected sound parameter based on the parameter acquired at S201. The mirror method is used to generate a reflected sound parameter. The mirror method places a virtual reflection sound source at a position symmetric about the wall, ceiling, or the road that reflects the sound.

The virtual sound image localization parameter calculation device 101 calculates virtual reflection sound sources for the number of major reflecting planes such as walls, ceilings, or roads. Suppose a case where there is no reflecting plane or the reflecting plane is small. In such a case, the virtual sound image localization parameter calculation device 101 mutes or attenuates the reflected sound in the corresponding direction. More than one reflected sound is synthesized if the vehicle runs on an urban express highway surrounded by walls or ceilings. Little reflected sound is synthesized if the vehicle runs on a bank. The effect well matches the actual auditory perception outside the vehicle.

The virtual sound image localization parameter calculation device 101 may calculate the reflected sound parameter considering a situation where the sound reflects on the wall, the ceiling, or the road several times and reaches a hearing position. In this manner, the actual environment outside the vehicle can be more accurately simulated.

The virtual sound image localization parameter calculation device 101 assumes a point positioned at a mirror image against the reflecting wall to be the coordinate for the virtual reflection sound source based on the information about the environment around the vehicle and the recognized object coordinate acquired at 5201. Calculating the virtual reflection sound source coordinate can provide the reflected sound synthesis device 103 with the distance information as well as the direction information. The virtual sound image localization parameter calculation device 101 can simulate the distance attenuation effect of decreasing the loudness in proportion to the increasing distance and the Doppler effect based on an action of moving toward or away from an object. In addition, the virtual sound image localization parameter calculation device 101 can accurately calculate an arrival time difference based on a path difference between the direct sound and the reflected sound. In this manner, the actual environment outside the vehicle can be more accurately simulated.

There may be a long distance between the virtual reflection sound source and the hearing position. In such a case, a sound attenuation due to the air tends to decrease energy at a high frequency band more than energy at a low frequency band. The virtual sound image localization parameter calculation device 101 settles a coefficient (high-frequency distance attenuation correction parameter) to simulate this phenomenon. In this manner, the actual environment outside the vehicle can be more accurately simulated.

The virtual reflection sound source may contain frequency-amplitude characteristics based on the information about the environment around the vehicle acquired at 5201. For example, a concrete wall indicates a small sound absorption coefficient and flat frequency-amplitude characteristics for the reflected sound. Gravel or turf indicates a large sound absorption coefficient and frequency-amplitude characteristics of easily absorbing the sound at higher frequency bands. As a result, gravel or turf decreases the reflected sound magnitude in all bands and especially decreases the magnitude at higher frequency bands. To simulate such reflected sound characteristics, the virtual sound image localization parameter calculation device 101 uses the information acquired at S201 to calculate frequency-amplitude characteristics to be supplied to each virtual reflection sound source.

At S205, the virtual sound image localization parameter calculation device 101 notifies the reflected sound synthesis device 103 of the parameter calculated at S204.

At S206, the virtual sound image localization parameter calculation device 101 simulates reverberation occurring when the presentation sound is reflected several times in the environment outside the vehicle. To do this, the virtual sound image localization parameter calculation device 101 calculates frequency characteristics of the reverberant sound needed for the reverberant sound synthesis based on the parameter acquired at S201. This is described in more detail below.

The virtual sound image localization parameter calculation device 101 adjusts the reverberation time for each frequency band based on the information about the environment around the vehicle acquired at S201. For example, the space surrounded by a concrete wall indicates a small sound absorption coefficient and therefore lengthens the reverberation time. Conversely, the space surrounded by clothed people indicates a large sound absorption coefficient and therefore shortens the reverberation time and moreover shortens the reverberation time at higher frequency bands. To simulate such characteristics, the virtual sound image localization parameter calculation device 101 uses the information acquired at S204 to calculate the reverberation time for each frequency band.

The virtual sound image localization parameter calculation device 101 adjusts the loudness of reverberant sounds arriving from different directions based on the information about the recognized object and the environment around the vehicle acquired at S201. If a direct sound image is positioned at a long distance, for example, the virtual sound image localization parameter calculation device 101 synthesizes attenuated reverberant sounds in directions other than the direct sound image. The virtual sound image localization parameter calculation device 101 widens a direction to distribute reverberant sounds as the direct sound image reaches the hearing position. Finally, the virtual sound image localization parameter calculation device 101 adjusts the reverberant sounds to the same loudness in all directions. The virtual sound image localization parameter calculation device 101 synthesizes attenuated reverberant sounds in a direction surrounded by no walls. This can simulate the real environment outside the vehicle more accurately than providing reverberant sounds of the same loudness in all directions.

At S207, the virtual sound image localization parameter calculation device 101 notifies the reverberant sound synthesis device 104 of the parameter calculated at S206.

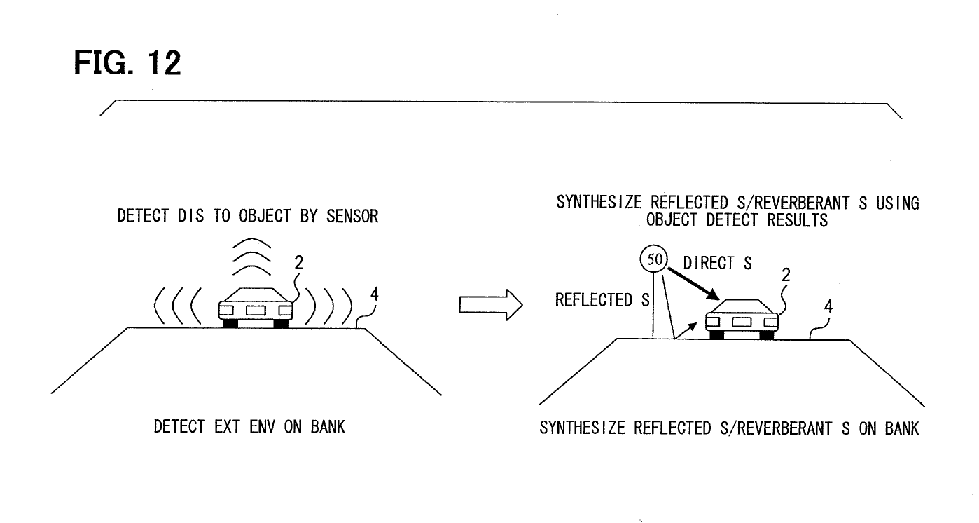

As described above, the virtual sound image localization parameter calculation device 101 settles a condition to generate the reflected sound or the reverberant sound according to the situation outside the vehicle 2. FIG. 12 illustrates an example of calculating the virtual sound image localization parameter used when the vehicle 2 is running on a bank. In this case, the object recognition device 302 recognizes only a road 4 as an object. Accordingly, the virtual sound image localization parameter calculation device 101 transmits a command to the reflected sound synthesis device 103 so that the command calculates and outputs only direct sound from a virtual sound image position and the reflected sound from the road 4. Further, the virtual sound image localization parameter calculation device 101 transmits a command to the reverberant sound synthesis device 104 so that the command synthesizes the reverberation whose reverberant sound is short, or, whose reverberant sound has a small reverberation index such as RT60. The virtual sound image localization parameter calculation device 101 also transmits a command to adjust frequency characteristics of the reverberation according to a surface shape of the road 4.

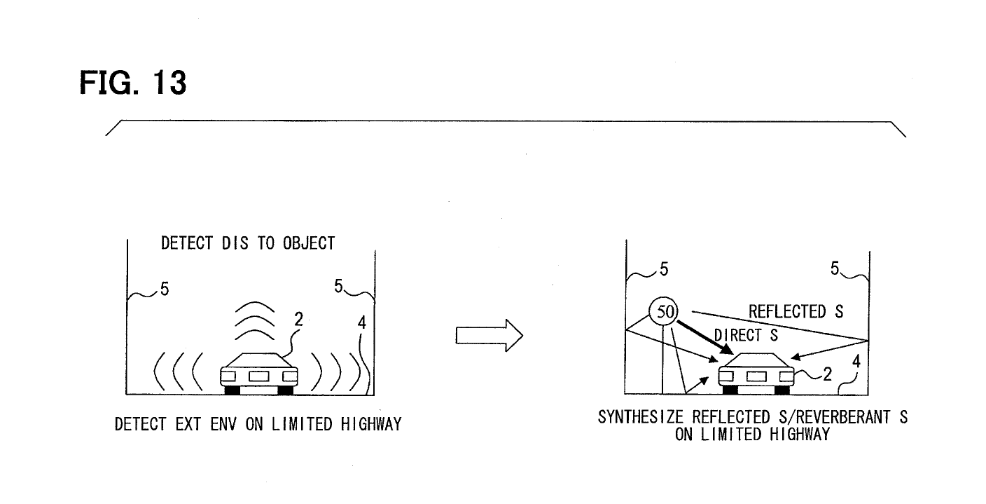

FIG. 13 illustrates an example of calculating the virtual sound image localization parameter used when the vehicle 2 is running on an express highway or a similar road surrounded by a sound insulation wall. In this case, the object recognition device 302 detects the road 4 and right and left walls 5. The virtual sound image localization parameter calculation device 101 transmits a command to the reflected sound synthesis device 103 so that the command calculates and outputs the direct sound from the virtual sound image position, the reflected sound from the road 4, and the reflected sound from the right and left walls 5. The virtual sound image localization parameter calculation device 101 transmits a command to the reverberant sound synthesis device 104 so that the command synthesizes the reverberation whose reverberant sound is long, or, whose reverberant sound has a large reverberation index such as RT60. The virtual sound image localization parameter calculation device 101 also transmits a command to adjust frequency characteristics of the reverberation or another command to decrease the level of reverberant sound which comes from above the listener according to surface shapes of the walls 5 and the road 4.

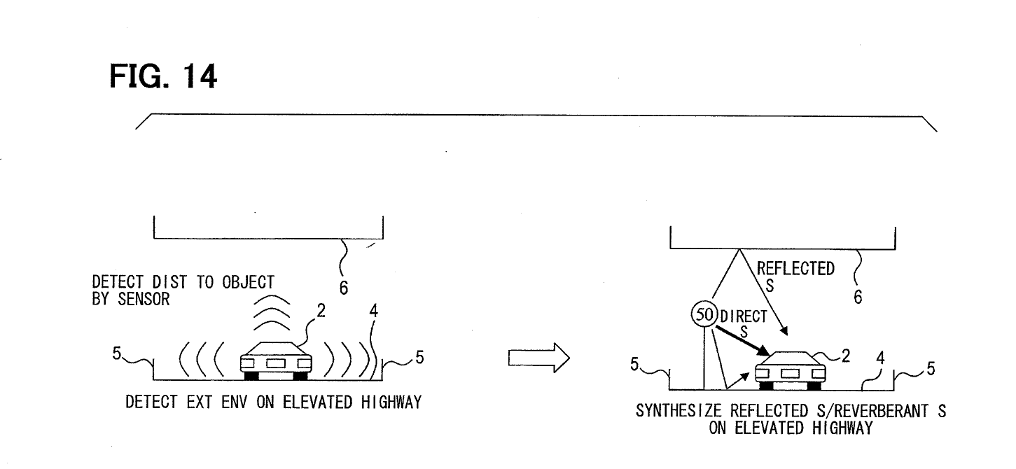

FIG. 14 illustrates an example of calculating the virtual sound image localization parameter used when the vehicle 2 is running on an elevated highway. In this case, the object recognition device 302 detects the reflected sound from the road 4 and the ceiling 6. The virtual sound image localization parameter calculation device 101 transmits a command to the reflected sound synthesis device 103 so that the command calculates and outputs the direct sound from the virtual sound image position, the reflected sound from the road 4, and the reflected sound from the ceiling 6. The virtual sound image localization parameter calculation device 101 transmits a command to the reverberant sound synthesis device 104 so that the command synthesizes the reverberation whose reverberant sound is long (or has a large reverberation index e.g. RT60). The virtual sound image localization parameter calculation device 101 also transmits a command to adjust frequency characteristics of the reverberation or another command to decrease the level of reverberant sound in the horizontal direction according to surface shapes of the ceiling 6 and the road 4.

At S300 in FIG. 5, the direct sound synthesis device 102 synthesizes a direct sound. The sound source of the direct sound is equivalent to that of the ambient information presentation sound generated as described above. Based on the information supplied from the virtual sound image localization parameter calculation device 101, the direct sound synthesis device 102 controls the arrival direction of a wavefront arrived from the virtual sound image position, the attenuation due to the distance, and a wavefront curvature radius due to the distance. Specifically, the direct sound synthesis device 102 synthesizes a wavefront using existing technologies such as amplitude panning, WFS (Wave Field Synthesis), and HOA (Higher Order Ambisonics). The attenuation due to the distance may be capable of adjusting exponent x so as to formulate 1/(distance)ₓ (0≦x). The reason is to continuously reproduce intermediates of the following ideal sound attenuations and more accurately simulate the actual environment.

Attenuation of a sound wave radiated from a point sound source: 1/(distance)¹

Attenuation of a sound wave radiated from a line sound source: 1/(distance)^{1/2}

Attenuation of a sound wave radiated from a plane sound source: 1/(distance)⁰ (i.e., no attenuation)

The relationship between a wavelength and a sound source size determines whether the line sound source can be assumed as an infinite line source or the plane sound source can be assumed as infinite plane source. Therefore, exponent x may be equivalent to a function of the frequency or a function of the size of an intended virtual sound source. If located at a given distance or longer away from a sound source, humans tend to sense a sound image at a distance shorter than the actual distance where the sound source is placed. Exponent x may be set to 1 or greater so that the sound image is sensed at a longer distance.

At S400, the reflected sound synthesis device 103 synthesizes a reflected sound. The sound source of the reflected sound is also equivalent to that of the ambient information presentation sound generated as described above. Based on the information supplied from the virtual sound image localization parameter calculation device 101, the reflected sound synthesis device 103 controls the arrival direction of a wavefront arrived from the virtual sound image position of the reflected sound, the attenuation due to the distance, a wavefront curvature radius due to the distance, and frequency characteristics of a reflector. The reflected sound synthesis device 103 uses the same technique as the direct sound synthesis device 102 uses. Concerning the number of reflections, the reflected sound synthesis device 103 may simulate one-time reflection in six directions, namely, up, down, right, left, forward, and backward, or may simulate more than one reflection. The reflected sound synthesis device 103 synthesizes a reflected sound as similar to the one under the actual environment as possible based on the information acquired from the virtual sound image localization parameter calculation device 101, as needed, in synchronization with surrounding situations where the vehicle 2 is running.

At S500, the reverberant sound synthesis device 104 synthesizes a reverberant sound. The sound source of the reverberant sound is also equivalent to that of the ambient information presentation sound generated as described above. Conditions to synthesize the reverberant sound include the reverberation time for each band or the loudness of the reverberant sound in each direction. The reverberant sound synthesis device 104 uses existing technologies that use an all-pass filter or a comb filter.

In order to present a spatial extent of space, in which the listener is disposed, or a distance between the virtual sound source and the listener with using reverberant sound, interaural correlation of reverberant sound heard by the listener needs to be decreased.

In order to reduce the interaural correlation of reverberant sound, the sound presentation apparatus 1 provides a diffuse sound field in a compartment of a vehicle by reproducing a reverberant sound using loudspeaker 402a through 402k.

In order to reproduce a diffuse sound field by loudspeakers 402a through 402k, all of the loudspeakers 402a through 402k output the reverberant sound at the same loudness and independent from each other.

In order to reproduce independent reverberant sound, different and independent reverb generation blocks are used in sound signal injecting loudspeakers 402a through 402k.

However, actual roads are not an ideal diffused sound field. Therefore, reverberant sound outputs may be increased or decreased in specific directions in order to adjust an interior sound field to the actual environment.

An ideal diffused sound field is defined as a sound field in which the energy density is uniformed at all locations and the flow of energy is equally probable in all directions.

With respect to the actual reverberant sound, the reverberation time varies with frequency bands due to an effect of frequency characteristics of the attenuation caused by the air or those of the reflection coefficient. Generally, a high frequency sound tends to be the short reverberation time. To reproduce this, a feedback element with a scalar gain for each comb filter is replaced with a filter having specific frequency characteristics. The reverberant sound synthesis device 104 may vary the frequency characteristics of the filter according to the surrounding situation for the vehicle 2 to run based on the information acquired from the virtual sound image localization parameter calculation device 101. The reverberant sound synthesis device 104 can thereby synthesize a reverberant sound more similar to the actual environment.

Suppose that the direct sound has sound pressure α and the reverberant sound has sound pressure β. In this case, a ratio between α and β can be configured to satisfy equation 1 as follows.

α/β=1/R^{x} (Equation 1)

where R denotes a distance between a specified hearing position (driver's ear position) and the virtual sound source and x denotes a constant greater than or equal to 0.

At S600, the actual background sound adjustment device 105 adjusts the actual background sound. The actual background sound is reproduced from the loudspeakers 402a through 402k in the interior (see FIG. 4). The actual background sound is equivalent to a sound field (sound pressure field) outside the vehicle collected by the exterior microphones 208a through 208k. The actual background sound adjustment device 105 synthesizes the actual background sound by adjusting the amplitude and the phase for each frequency band. Specifically, the actual background sound adjustment device 105 synthesizes wavefronts for the actual background sound using such methods as WFS(Wave Field Synthesis), boundary surface control, HOA (Higher Order Ambisonics). When hearing the actual background sound, interior occupants including the driver can feel as if the sound passes through the door or the ceiling.

At S700, the virtual sound image localization parameter calculation device 101 mixes outputs from the direct sound synthesis device 102, the reflected sound synthesis device 103, the reverberant sound synthesis device 104, and the actual background sound adjustment device 105 and supplies a signal to the amplifiers 401a through 401k.

At S800, the virtual sound image localization parameter calculation device 101 determines whether a specified time (ranging from several hundreds of milliseconds to several seconds) has elapsed after the most recent process at S100. If the specified time has elapsed, control proceeds to S100 because the virtual sound image localization parameter calculation device 101 determines that the process at 5100 needs to be performed. Otherwise, control proceeds to S200.

(2-2) Ambient Information Presentation Sound Output Process

(a) Recognizing a Traffic Signal (Green Light or Arrow)

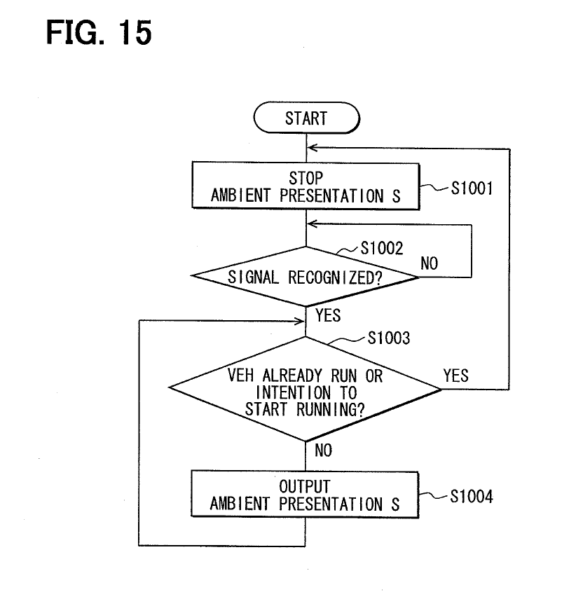

The following describes the ambient information presentation sound output process to recognize a traffic signal (green light or arrow). At S1001 in FIG. 15, the sound presentation apparatus 1 stops output of the ambient information presentation sound if it is output at the point. The sound presentation apparatus 1 does nothing if the ambient information presentation sound is not output at the point.

At S1002, the sound presentation apparatus 1 determines whether a green signal is recognized. The green signal signifies a traffic signal concerning lanes for the vehicle 2 and is provided as a green indication or a green arrow notifying the permission of passage. The exterior camera 202 or the exterior sensor 203 recognizes the green signal. If the green signal is recognized, control proceeds to S1003. Otherwise, control remains at S1002.

At S1003, the sound presentation apparatus 1 determines whether the vehicle 2 is already running or the driver expresses his or her intention to start running the vehicle 2 by shifting a gear lever to the drive range or the first or second gear or releasing a brake pedal. If the result is NO, control proceeds to S1004. If the result is YES, control proceeds to S1001.

At S1004, the sound presentation apparatus 1 starts outputting the ambient information presentation sound from the loudspeakers 402a through 402k. This process continues until control proceeds to S1001 next time. The ambient information presentation sound uses a signal position as the virtual sound source and provides stereophony whose sound image localization direction matches the virtual sound source. Control then proceeds to S1003.

(b) Recognizing a Traffic Signal (Yellow or Red Light)

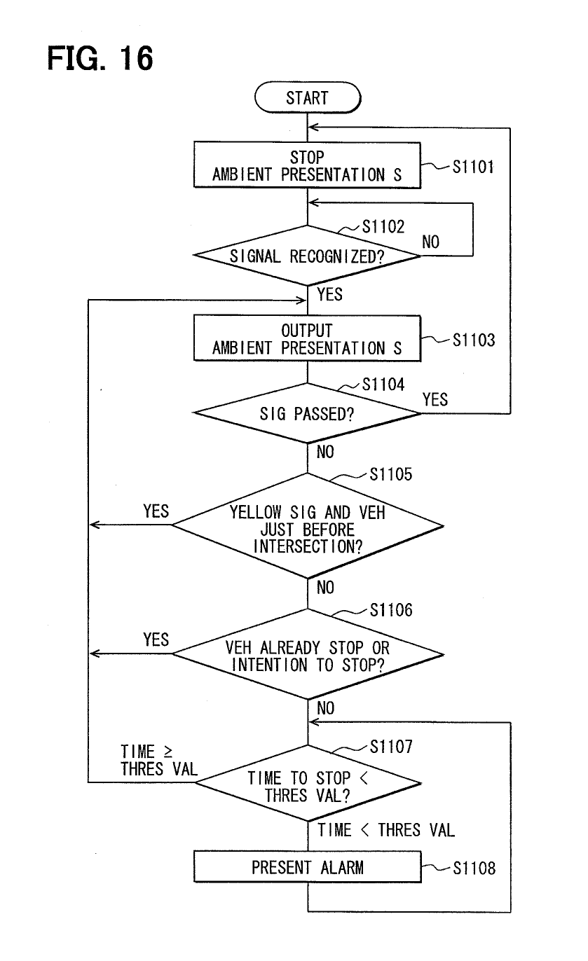

The following describes the ambient information presentation sound output process to recognize a traffic signal (yellow or red light). At S1101 in FIG. 16, the sound presentation apparatus 1 stops output of the ambient information presentation sound if it is output at the point. The sound presentation apparatus 1 does nothing if the ambient information presentation sound is not output at the point.

At S1102, the sound presentation apparatus 1 determines whether a yellow or red signal is recognized. The yellow or red signal signifies a traffic signal concerning lanes for the vehicle 2 and is provided as a yellow or red indication notifying the vehicle stop. The exterior camera 202 or the exterior sensor 203 recognizes the yellow or red signal. If the yellow or red signal is recognized, control proceeds to S1103. Otherwise, control remains at S1102.

At S1103, the sound presentation apparatus 1 starts outputting the ambient information presentation sound from the loudspeakers 402a through 402k. This process continues until control proceeds to S1101 next time. The ambient information presentation sound uses a signal position as the virtual sound source and provides stereophony whose sound image localization direction matches the virtual sound source.

At S1104, the sound presentation apparatus 1 determines whether the vehicle 2 has already passed the yellow or red signal or the signal has turned green. If the result is NO, control proceeds to S1105. If the result is YES, control proceeds to S1101.

At S1105, the sound presentation apparatus 1 determines whether the yellow signal turns on, the vehicle 2 is positioned immediately before an intersection, and only sudden braking stops the vehicle 2. If the result is NO, control proceeds to S1106. If the result is YES, control proceeds to S1103. At S1106, the sound presentation apparatus 1 determines whether the vehicle 2 already stops or the driver expresses his or her intention to stop the vehicle 2 by taking action such as operating the brake, the accelerator, or the gear shift lever. If the result is NO, control proceeds to S1107. If the result is YES, control proceeds to S1103.

At S1107, the sound presentation apparatus 1 determines whether a difference (margin) between the current time and the estimated time limit for stopping at a stop-line is smaller than the threshold value. If the difference is smaller than the threshold value, control proceeds to S1108. If the difference is greater than or equal to the threshold value, control proceeds to S1103.

At S1108, the sound presentation apparatus 1 allows the loudspeakers 402a through 402k to present an alarm sound.

(c) Recognizing a Speed Limit Sign

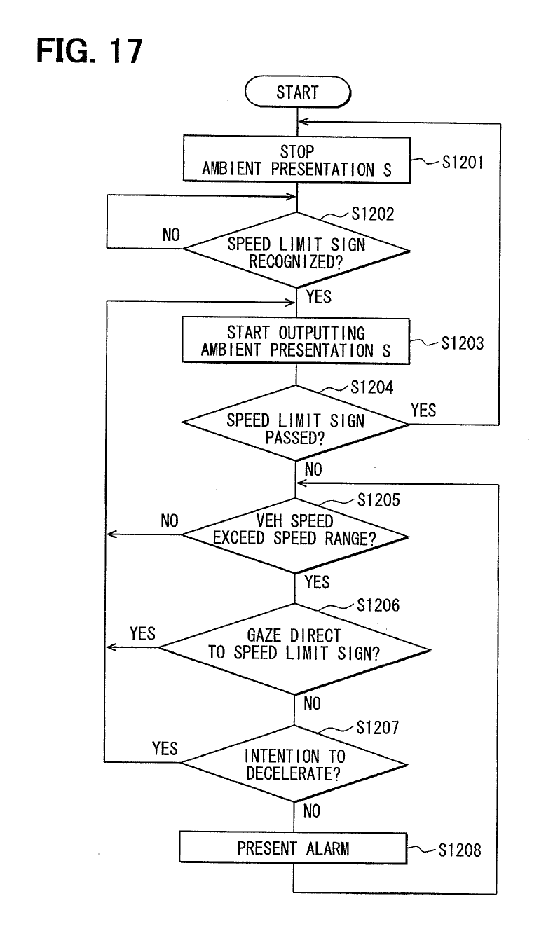

The following describes the ambient information presentation sound output process to recognize a speed limit sign. At S1201 in FIG. 17, the sound presentation apparatus 1 stops output of the ambient information presentation sound if it is output at the point. The sound presentation apparatus 1 does nothing if the ambient information presentation sound is not output at the point.

At S1202, the sound presentation apparatus 1 determines whether a speed limit sign concerning lanes for the vehicle 2 is recognized. The exterior camera 202 or the exterior sensor 203 recognizes a speed limit sign. If a speed limit sign is recognized, control proceeds to S1203. Otherwise, control remains at S1202.

At S1203, the sound presentation apparatus 1 starts outputting the ambient information presentation sound from the loudspeakers 402a through 402k. This process continues until control proceeds to S1201 next time. The ambient information presentation sound uses a speed limit sign position as the virtual sound source and provides stereophony whose sound image localization direction matches the virtual sound source.

At S1204, the sound presentation apparatus 1 determines whether the vehicle 2 has already passed the speed limit sign. If the result is NO, control proceeds to S1205. If the result is YES, control proceeds to S1201.

At S1205, the sound presentation apparatus 1 determines whether the speed of the vehicle 2 at that point exceeds a speed range regulated by the speed limit sign. To exceed the speed range means the speed of a vehicle is greater than a maximum speed regulated by the speed limit sign or is smaller than a minimum speed regulated by the speed limit sign. If the speed of the vehicle 2 exceeds the range, control proceeds to S1206. Otherwise, control proceeds to S1203.

At S1206, the sound presentation apparatus 1 determines whether the driver's gaze was directed toward the speed limit sign for a specified time or longer. The interior camera 201 detects the driver's gaze. If the driver's gaze was not directed toward the speed limit sign for a specified time or longer, control proceeds to S1207. Otherwise, control proceeds to S1203.

At S1207, the sound presentation apparatus 1 determines whether the operation of the brake or the accelerator corresponding to the driver's intention to control the speed of the vehicle 2 into the speed range regulated by the speed limit sign is detected. If the result is NO, control proceeds to S1208. If the result is YES, control proceeds to S1203.

At S1208, the sound presentation apparatus 1 allows the loudspeakers 402a through 402k to present an alarm sound.

(d) Recognizing a No-Entry Sign

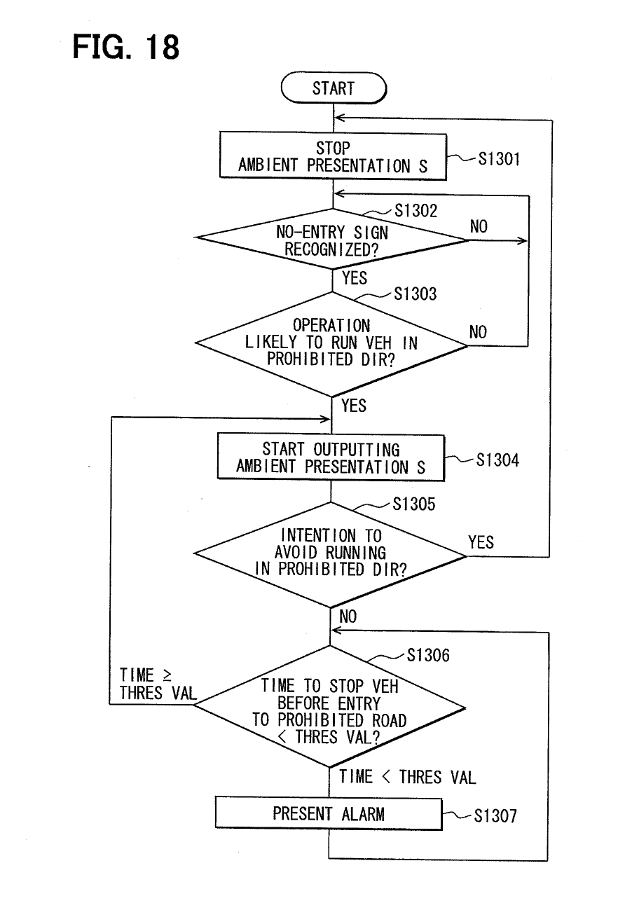

The following describes the ambient information presentation sound output process to recognize a no-entry sign. At S1301 in FIG. 18, the sound presentation apparatus 1 stops an ambient information presentation sound if it is output at the point. The sound presentation apparatus 1 does nothing if the ambient information presentation sound is not output at the point.

At S1302, the sound presentation apparatus 1 determines whether a no-entry sign is recognized. The no-entry sign notifies that the road is closed or the vehicle is prohibited from entering the road or the lane. The exterior camera 202 or the exterior sensor 203 recognizes a no-entry sign. If a no-entry sign is recognized, control proceeds to S1303. Otherwise, control remains at S1302.

At S1303, the sound presentation apparatus 1 determines whether the driver operates a turn signal switch or a steering wheel or performs a operation that leads the vehicle to proceed in the direction prohibited by the no-entry sign. If such an operation is performed, control proceeds to S1304. Otherwise, control proceeds to S1302.

At S1304, the sound presentation apparatus 1 starts outputting the ambient information presentation sound from the loudspeakers 402a through 402k. This process continues until control proceeds to S1301 next time. The ambient information presentation sound uses a no-entry sign position as the virtual sound source and provides stereophony whose sound image localization direction matches the virtual sound source.

At S1305, the sound presentation apparatus 1 determines whether the driver operates the brake, the steering wheel, or the turn signal switch or performs a operation that leads the vehicle to avoid proceeding in the direction prohibited by the no-entry sign. If such an operation is not performed, control proceeds to S1306. Otherwise, control proceeds to S1301.

At S1306, the sound presentation apparatus 1 determines whether a difference (margin) between the current time and the estimated time limit for stopping before entry into the prohibited road is smaller than the threshold value. If the difference is smaller than the threshold value, control proceeds to S1307. If the difference is greater than or equal to the threshold value, control proceeds to S1304.

At S1307, the sound presentation apparatus 1 allows the loudspeakers 402a through 402k to present an alarm sound.

3. Effects of the Sound Presentation Apparatus 1

(1) The sound presentation apparatus 1 outputs an ambient information presentation sound if the driver fails to notice a traffic signal or a road sign. The driver can notice the failure.

(2) The ambient information presentation sound is generated based on the interior sound so as to satisfy condition A below. The driver does not feel annoyed if the ambient information presentation sound is output continuously under a situation where there is no need to output the sound.

Condition A: The sound pressure level of the ambient information presentation sound is higher than the sound pressure level of the interior sound in some frequency bands and is lower than or equal to the same in the other frequency bands.

(3) The ambient information presentation sound is generated based on the interior sound so as to satisfy condition B below. The driver can easily recognize an object notified by the ambient information presentation sound.

Condition B: The stereophony indicates the sound image localization direction that approximately matches the virtual sound source.

(4) The sound presentation apparatus 1 outputs an actual background sound in the interior and thereby provides the following effects.

Humans always unconsciously correct an auditory perception of distance or direction according to a visual perception of distance or direction. While driving a vehicle, the driver can continue to adapt a auditory perception of distance or direction according to a visual perception of distance or direction. This is unavailable for existing vehicles. As a result, an auditory perception of distance or direction provides unsatisfactory accuracy.

The sound presentation apparatus 1 reproduces actual background sound in real time and an actual sound field itself in the interior. The sound presentation apparatus 1 thereby ensures a state that enables a person to continuously adapt a auditory perception of distance or direction according to a visual perception of distance or direction. The result is to ensure higher localization accuracy than presenting the ambient information presentation sound to a driver who has experienced no learning in a silent state. The actual background sound and the ambient information presentation sound can be compared with each other. This can also improve the localization accuracy. The actual background sound can function as a background masker noise that prevents the ambient information presentation sound from being exceedingly noticeable.

It is to be distinctly understood that the present disclosure is not limited to the above-mentioned embodiment but may be otherwise variously embodied within the spirit and scope of the disclosure.

For example, the sound presentation apparatus 1 may detect a specified driver operation or a specified behavior of the vehicle 2 and may output an ambient information presentation sound according to the detection result.

The above disclosure has the following aspects.

According to an example aspect of the present disclosure, an ambient information notification apparatus for a vehicle includes: an interior sound acquisition device that acquires a sound in a compartment of the vehicle, which is referred as an interior sound; an ambient information presentation sound generator that generates an ambient information presentation sound, which satisfies a first condition and a second condition with regard to the interior sound; and an ambient information presentation sound output device that outputs the ambient information presentation sound. The first condition is that a sound pressure level of the ambient information presentation sound is higher than the interior sound in a predetermined frequency band, and is lower than or equal to the interior sound in other frequency band. The second condition is that the ambient information presentation sound is provided by stereophony, in which a sound image localization direction approximately directs to a virtual sound source.

The ambient information notification apparatus can output an ambient presentation sound if a driver fails to notice a traffic signal or a road sign, for example. This can prevent a failure to notice the traffic signal or the road sign.

The ambient presentation sound is generated based on the interior sound so as to satisfy the first condition described above. The driver does not feel annoyed if the ambient presentation sound is output continuously under a situation where there is no need to output the sound.

The ambient presentation sound provides stereophony that satisfies the second condition described above. The driver can easily recognize an object notified by the ambient presentation sound.

Alternatively, the ambient information notification apparatus may further include: an exterior object detector that detects an exterior object disposed on an outside of the vehicle. The external object includes at least one of a traffic light and a traffic sign. The external object provides the virtual sound source's property. The interior sound acquisition device is a microphone, the ambient information presentation sound generator is an electric control unit, and the ambient information presentation sound output device is a loudspeaker. The sound image localization direction is a direction, from which a sound is heard. The ambient information presentation sound is a warning sound or a voice message relating to the external object.

Alternatively, the ambient information notification apparatus may further include: an actual background sound acquisition device that acquires an actual background sound as a sound field of an outside of the vehicle; and an actual background sound reproduction device that reproduces the actual background sound in the compartment of the vehicle. Further, the actual background sound acquisition device may be an external microphone, and the actual background sound reproduction device may be an actual background sound adjustment device, which is provided by an electric control unit.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. An ambient information notification apparatus for a vehicle comprising:
an interior sound acquisition device that acquires a sound in a compartment of the vehicle, which is referred as an interior sound;
an ambient information presentation sound generator that generates an ambient information presentation sound, which satisfies a first condition and a second condition with regard to the interior sound; and
an ambient information presentation sound output device that outputs the ambient information presentation sound,
wherein the first condition is that a sound pressure level of the ambient information presentation sound is higher than the interior sound in a predetermined frequency band, and is lower than or equal to the interior sound in other frequency band, and
wherein the second condition is that the ambient information presentation sound is provided by stereophony, in which a sound image localization direction approximately directs to a virtual sound source.

2. The ambient information notification apparatus according to claim 1, further comprising:
an exterior object detector that detects an exterior object disposed on an outside of the vehicle,
wherein the external object includes at least one of a traffic light and a traffic sign,
wherein the external object provides the virtual sound source's property,
wherein the interior sound acquisition device is a microphone, the ambient information presentation sound generator is an electric control unit, and the ambient information presentation sound output device is a loudspeaker,
wherein the sound image localization direction is a direction, from which a sound is heard, and
wherein the ambient information presentation sound is a warning sound or a voice message relating to the external object.

3. The ambient information notification apparatus according to claim 1, further comprising:
a first situation detector that detects at least one of an exterior object disposed on an outside of the vehicle, a driver operation, and a vehicle behavior,
wherein the ambient information presentation sound output device outputs the ambient information presentation sound according to a detection result of the first situation detection device.

4. The ambient information notification apparatus according to claim 3,
wherein the exterior object is a road sign or a traffic signal.

5. The ambient information notification apparatus according to claim 1, further comprising:
a second situation detector that detects a situation in an outside of the vehicle; and
a reflection and reverb condition setup device that sets a generation condition of one of a reflected sound and a reverberant sound according to a detection result of the second situation detection device,
wherein the ambient information presentation sound includes a direct sound, the reflected sound and the reverberant sound.

6. The ambient information notification apparatus according to claim 5,
wherein the generation condition of the reverberant sound relates to one of reverberation time of each band and a loudness of the reverberant sound in each direction.

7. The ambient information notification apparatus according to claim 5,
wherein sound pressure of the direct sound is referred as α, and sound pressure of the reverberant sound is referred as β,
wherein a ratio between α and β is calculated by an equation of: α/β=1/Rₓ,
wherein R denotes a distance between a predetermined hearing position and the virtual sound source, and
wherein x denotes a constant, which is greater than or equal to 0.

8. The ambient information notification apparatus according to claim 1, further comprising:
an actual background sound acquisition device that acquires an actual background sound as a sound field of an outside of the vehicle; and
an actual background sound reproduction device that reproduces the actual background sound in the compartment of the vehicle.

9. The ambient information notification apparatus according to claim 8,
wherein the actual background sound acquisition device is an external microphone, and
wherein the actual background sound reproduction device is an actual background sound adjustment device, which is provided by an electric control unit.
